(19) United States
(12) Patent Application Publication
(10) Pub. No.: US 2018/0183936 A1
(43) Pub. Date: Jun. 28, 2018

(54) METHOD AND APPARATUS FOR MANAGING CONFERENCE CALL, TERMINAL AND NETWORK DEVICE

(71) Applicant: SPREADTRUM COMMUNICATIONS (SHANGHAI) CO., LTD., Shanghai (CN)

(72) Inventors: Xichun Gao, Shanghai (CN); Xianliang Chen, Shanghai (CN); Yuting Cai, Shanghai (CN); Yi He, Shanghai (CN)

(21) Appl. No.: 15/811,693

(22) Filed: Nov. 14, 2017

(30) Foreign Application Priority Data
Dec. 22, 2016 (CN) 201611199731.9

(51) Int. Cl. H04M 3/56; H04W 4/16

(52) U.S. Cl. CPC H04M 3/56; H04W 84/12; H04W 4/16

(57) ABSTRACT

A method and an apparatus for managing a conference call, a terminal and a network device are provided. The method includes transmitting a first request to a network during a current conference call, so that the network can control at least one end of the current conference call not to transmit service data, or the network cannot forward the service data of the at least one end to other ends of the conference call, or the network can forward the service data of the at least one end to designated ends of the conference call. Designated subscribers in a conference call can be muted and a partial conference can be made among designated subscribers of a conference call, and the designated subscribers can be stopped from being muted and the conference call among all ends can be restored, thereby satisfying diversified requirements of users.

### CROSS-REFERENCE TO RELATED APPLICATIONS

This application claims the benefit of priority to Chinese Patent Application No. 201611199731.9, titled “METHOD AND APPARATUS FOR MANAGING CONFERENCE CALL, TERMINAL AND NETWORK DEVICE”, filed on Dec. 22, 2016, the entire disclosure of which are incorporated herein by reference.

### TECHNICAL FIELD

The present disclosure relates to communication technology field, and more particularly, to a method and an apparatus for managing a conference call, a terminal and a network device.

### BACKGROUND

With continuous improvement of mobile network bandwidth and optimization of mobile device performance, user demands for services provided by mobile terminals also gradually increase. Currently, the mobile terminal business has become more and more diversified compared with a one-to-one conventional call, for example, video calls, call forwarding and conference calls and other services has emerged in recent years. Conference function can be achieved by network in an existing conference call technology. During a conference call, all participants are available to speak at any time.

However, diversified requirements of users cannot be satisfied in the existing conference call scenario.

### SUMMARY

A method and an apparatus for managing a conference call, a terminal and a network device are provided according to embodiments of the present disclosure. Designated subscribers in a conference call can be muted and a partial conference can be made among designated subscribers of a conference call, thereby satisfying diversified requirements of users.

A method for managing a conference call is provided according to embodiments. The method may include: transmitting a first request to a network during a current conference call, so that the network can control at least one end of the current conference call not to transmit service data, or the network cannot forward the service data of the at least one end to other ends of the conference call, or the network can forward the service data of the at least one end to designated ends of the conference call.

In one embodiment, after transmitting the first request to the network during the current conference call, so that the network can control at least one end of the current conference call not to transmit service data, or the network cannot forward the service data of the at least one end to other ends of the conference call, or the network can forward the service data of the at least one end to designated ends of the conference call, the method further includes receiving a first acknowledgment response returned by the network.

In one embodiment, after transmitting the first request to the network, so that the network can control the at least one end of the current conference call not to transmit service data, or the network cannot forward the service data of the at least one end to other ends of the conference call, or the network can forward the service data of the at least one end to designated ends of the conference call, the method further includes: transmitting a second request to the network, so that the network can stop controlling at least one end of the current conference call not to transmit the service data, or the network can stop not forwarding the service data of the at least one end to other ends of the conference call, or the network can stop forwarding the service data of the at least one end to designated ends of the conference call; and receiving a second acknowledgment response returned by the network.

In one embodiment, the above-described method for managing a conference call may be applied to a terminal based on IP multimedia network, or to a terminal based on IP Multimedia Subsystem (IMS) network.

In one embodiment, the above-described method for managing a conference call may be applied to a terminal supporting Voice over LTE (VoLTE) or a terminal supporting Voice over WiFi (VoWiFi).

A method for managing a conference call that is applied to a network is also provided according to embodiments. The method may include: receiving a first request transmitted by a terminal side during a current conference call; and controlling at least one end of the current conference call not to transmit service data, or controlling the network not to forward the service data of the at least one end to other ends of the conference call, or controlling the network to forward the service data of the at least one end to designated ends of the conference call according to the first request transmitted by the terminal side.

In one embodiment, the method may further include transmitting a first acknowledgment response to the terminal side, after controlling the at least one end of the current conference call not to transmit service data, or controlling the network not to forward the service data of the at least one end to other ends of the conference call, or controlling the network to forward the service data of the at least one end to designated ends of the conference call according to the first request transmitted by the terminal side.

In one embodiment, after controlling the at least one end of the current conference call not to transmit service data, or controlling the network not to forward the service data of the at least one end to the other ends of the conference call, or controlling the network to forward the service data of the at least one end to designated ends of the conference call according to the first request transmitted by the terminal side, the method may further include: receiving a second request transmitted by the terminal side; stopping controlling at least one end of the current conference call not to transmit the service data, or stopping controlling the network not to forward the service data of the at least one end to other ends of the conference call, or stopping controlling the network to forward the service data of the at least one end to designated ends of the conference call; and transmitting an acknowledgement response to the terminal side.

An apparatus for managing a conference call is also provided according to embodiments. The apparatus may include a first requesting circuitry, which is configured to transmit a first request to a network during a current conference call, so that the network can control at least one end of the current conference call not to transmit service data, or the network cannot forward the service data of the at least one end to other ends of the conference call, or the network can forward the service data of the at least one end to designated ends of the conference call.

In one embodiment, the apparatus may further include a first receiving circuitry, which is configured to receive a first acknowledgment response returned by the network, after the first requesting circuitry transmits the first request to the network during the current conference call, so that the network can control the at least one end of the current conference call not to transmit service data, or the network cannot forward the service data of the at least one end to other ends of the conference call, or the network can forward the service data of the at least one end to designated ends of the conference call.

In one embodiment, the apparatus may further include a second requesting circuitry and a second receiving circuitry. The second requesting circuitry is configured to transmit a second request to the network, so that the network can stop controlling at least one end of the current conference call not to transmit the service data, or the network can stop not forwarding the service data of the at least one end to other ends of the conference call, or the network can forward the service data of the at least one end to designated ends of the conference call, after the first requesting circuitry transmits the first request to the network during the current conference call, so that the network can control the at least one end of the current conference call not to transmit service data, or the network cannot forward the service data of the at least one end to other ends of the conference call, or the network can forward the service data of the at least one end to designated ends of the conference call; and the second receiving circuitry is configured to receive an acknowledgment response returned by the network.

In one embodiment, the apparatus may be located at a terminal based on IP multimedia network or located at a terminal based on IP Multimedia Subsystem (IMS) network.

In one embodiment, the apparatus may be located at a terminal supporting Voice over LTE (VoLTE) or a terminal supporting Voice over WiFi (VoWiFi).

An apparatus for managing a conference call that is located at a network is also provided according to embodiments. The apparatus may include: a third receiving circuitry, configured to receive a first request transmitted by a terminal side during a current conference call; and a first controlling circuitry, configured to control at least one end of the current conference call not to transmit service data, or to control the network not to forward the service data of the at least one end to other ends of the conference call, or to control the network to forward the service data of the at least one end to designated ends of the conference call according to the first request transmitted by the terminal side.

In one embodiment, the apparatus may further include a first transmitting circuitry, which is configured to transmit an acknowledgment response to the terminal side, after the first controlling circuitry controls the at least one end of the current conference call not to transmit service data, or controls the network not to forward the service data of the at least one end to other ends of the conference call, or controls the network to forward the service data of the at least one end to designated ends of the conference call according to the first request transmitted by the terminal side.

In one embodiment, the apparatus may further include a fourth receiving circuitry, a second controlling circuitry and a second transmitting circuitry. The fourth receiving circuitry is configured to receive a second request transmitted by the terminal side, after the first controlling circuitry controls the at least one end of the current conference call not to transmit service data, or controls the network not to forward the service data of the at least one end to other ends of the conference call, or controls the network to forward the service data of the at least one end to designated ends of the conference call according to the first request transmitted by the terminal side; the second controlling circuitry is configured to stop controlling at least one end of the current conference call not to transmit the service data, or to stop controlling the network not to forward the service data of the at least one end to other ends of the conference call, or to stop controlling the network to forward the service data of the at least one end to designated ends of the conference call; and the second transmitting circuitry is configured to transmit an acknowledgement response to a host terminal.

A terminal is also provided according to embodiments. The terminal may include the above-described apparatus for managing a conference call, where the apparatus for managing a conference call may include a first requesting circuitry, which is configured to transmit a first request to a network during a current conference call, so that the network can control at least one end of the current conference call not to transmit service data, or the network cannot forward the service data of the at least one end to other ends of the conference call, or the network can forward the service data of the at least one end to designated ends of the conference call.

A network device is also provided according to embodiments. The network device may include the above-described apparatus for managing a conference call, where the apparatus for managing a conference call may include a third receiving circuitry, configured to receive a first request transmitted by a terminal side during a current conference call; and a first controlling circuitry, configured to control at least one end of the current conference call not to transmit service data, or to control the network not to forward the service data of the at least one end to other ends of the conference call, or to control the network to forward the service data of the at least one end to designated ends of the conference call according to the first request transmitted by the terminal side.

In the method and apparatus for managing a conference call, the terminal and the network device according to the embodiments of the present disclosure, a first request is transmitted to a network during a current conference call, so that the network can control at least one end of the current conference call not to transmit service data, or the network cannot forward the service data of the at least one end to other ends of the conference call, or the network can forward the service data of the at least one end to designated ends of the conference call. Compared with the existing technology, designated subscribers in a conference call can be muted and a partial conference can be made among designated subscribers of a conference call, thereby satisfying diversified requirements of users.

### BRIEF DESCRIPTION OF THE DRAWINGS

FIG. 1 schematically illustrates a flow chart of a method for managing a conference call according to an embodiment of the present disclosure;

FIG. 2 schematically illustrates a flow chart of a method for managing a conference call according to another embodiment of the present disclosure;

FIG. 3 schematically illustrates a structural diagram of an apparatus for managing a conference call according to an embodiment of the present disclosure;

FIG. 4 schematically illustrates a structural diagram of an apparatus for managing a conference call according to another embodiment of the present disclosure;

FIG. 5 schematically illustrates a structural diagram of an apparatus for managing a conference call according to another embodiment of the present disclosure; and

FIG. 6 schematically illustrates a structural diagram of an apparatus for managing a conference call according to another embodiment of the present disclosure.

### DETAILED DESCRIPTION

In order to make the above-mentioned objects, features and advantages of the present disclosure more easily understood, specific embodiments of the present disclosure will be described in detail with reference to the accompanying drawings below. Apparently, embodiments described below are merely a portion of embodiments of the present disclosure, and are not all embodiments. All other embodiments obtained by those of ordinary skill in the art without making creative work are within the scope of the present disclosure, based on embodiments disclosed hereinafter.

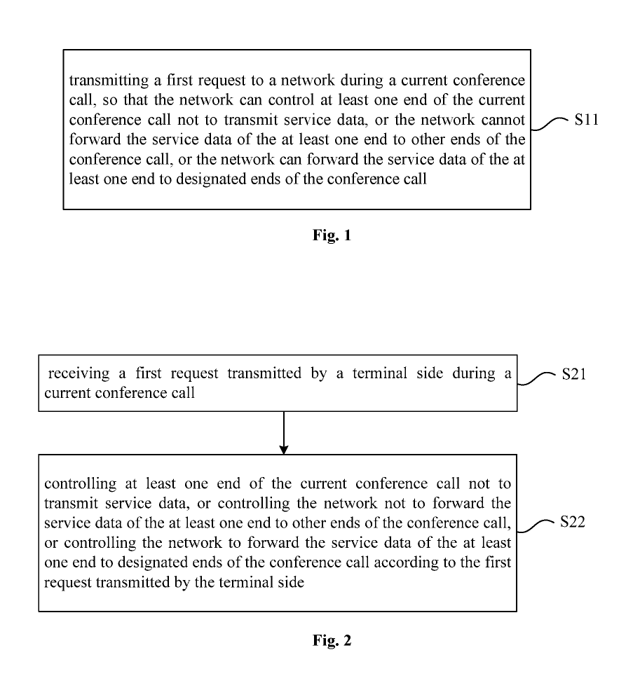

A method for managing a conference call that is applied to a host terminal is provided according to embodiments. Referring to FIG. 1, the method may include S11.

In S11, a first request is transmitted to a network during a current conference call, so that the network can control at least one end of the current conference call not to transmit service data, or the network cannot forward the service data of the at least one end to other ends of the conference call, or the network can forward the service data of the at least one end to designated ends of the conference call.

In the method for managing a conference call according to the embodiments of the present disclosure, a first request is transmitted to a network during a current conference call, so that the network can control at least one end of the current conference call not to transmit service data, or the network cannot forward the service data of the at least one end to other ends of the conference call, or the network can forward the service data of the at least one end to designated ends of the conference call. Compared with the existing technology, designated subscribers in a conference call can be muted and a partial conference can be made among designated subscribers in the conference call, therefore diversified requirements of users can be satisfied.

Specifically, the aforementioned method is applied to the host terminal, where the host may refer to a terminal subscriber that has a right to transmit a request to the network and to control a conference call.

In some embodiments, the method may further include receiving a first acknowledgment response returned by the network, after transmitting the first request to the network, so that the network can control at least one end of the current conference call not to transmit service data, or the network cannot forward the service data of the at least one end to other ends of the conference call, or the network can forward the service data of the at least one end to designated ends of the conference call.

In some embodiments, after transmitting the first request to the network, so that the network can control the at least one end of the current conference call not to transmit service data, or the network cannot forward the service data of the at least one end to other ends of the conference call, or the network can forward the service data of the at least one end to designated ends of the conference call, the method may further include: transmitting a second request to the network, so that the network can stop controlling the at least one end of the current conference call not to transmit the service data, or the network can stop not forwarding the service data of the at least one end to other ends of the conference call, or the network can stop forwarding the service data of the at least one end to designated ends of the conference call; and receiving a second acknowledgment response returned by the network.

In some embodiments, the method may be applied to a terminal based on IP multimedia network.

In some embodiments, the method may be applied to a terminal based on IP Multimedia Subsystem (IMS) network.

In some embodiments, the method may be applied to a terminal supporting Voice over LTE (VoLTE) or a terminal supporting Voice over WiFi (VoWiFi).

A method for managing a conference call that is applied to a network is also provided according to embodiments of the present disclosure. Referring to FIG. 2, in some embodiments, the method may include S21 and S22.

In S21, a first request transmitted by a terminal side is received during a current conference call.

In S22, at least one end of the current conference call is controlled not to transmit service data, or the network is controlled not to forward the service data of the at least one end to other ends of the conference call, or the network is controlled to forward the service data of the at least one end to designated ends of the conference call according to the first request transmitted by the terminal side.

In the method for managing a conference call that is applied to the network according to the embodiments of the present disclosure, the first request transmitted by the terminal is received during the current conference call; and the at least one end of the current conference call is controlled not to transmit service data, or the network is controlled not to forward the service data of the at least one end to other ends of the conference call, or the network is controlled to forward the service data of the at least one end to designated ends of the conference call according to the first request transmitted by the terminal side. Compared with the existing technology, designated subscribers in a conference call can be muted and a partial conference can be made among designated subscribers in the conference call, therefore diversified demands of users can be satisfied.

In some embodiments, the method further includes transmitting a first acknowledgment response to the terminal, after controlling the at least one end of the current conference call not to transmit service data, or controlling the network not to forward the service data of the at least one end to other ends of the conference call, or controlling the network to forward the service data of the at least one end to designated ends of the conference call according to the first request transmitted by the terminal side.

In some embodiments, after controlling the at least one end of the current conference call not to transmit service data, or controlling the network not to forward the service data of the at least one end to the other ends of the conference call, or controlling the network to forward the service data of the at least one end to designated ends of the conference call according to the first request transmitted by the terminal side, the method further includes: receiving a second request transmitted by the terminal side; stopping controlling the at least one end of the current conference call not to transmit the service data, or stopping controlling the network not to forward the service data of the at least one end to other ends of the conference call, or stopping controlling the network to forward the service data of the at least one end to designated ends of the conference call; and transmitting a second acknowledgement response to the terminal side. The terminal may be a host terminal.

The above methods will be described in detail below with reference to specific embodiments.

In some embodiments, a mobile terminal A, a mobile terminal B and a mobile terminal C are making a conference call, where the mobile terminal A is a host.

The method for managing a conference call that is applied to the terminal side may include the following steps:

transmitting a first request to a network, so that the network can control the mobile terminal B and the mobile terminal C in the current conference call not to transmit service data;

receiving a first acknowledgment response returned by the network;

transmitting a second request to the network, so that the network can stop controlling the mobile terminal B in the current conference call not to transmit the service data; and

receiving a second acknowledgment response returned by the network.

The method for managing a conference call that is applied to the network may include the following steps:

receiving a first request transmitted by the host mobile terminal A for controlling the mobile terminal B and the mobile terminal C in the current conference call not to transmit service data;

controlling the mobile terminal B and the mobile terminal C not to transmit service data according to the received first request;

transmitting a first acknowledgment response to the host mobile terminal A.

receiving a second request transmitted by the host mobile terminal A for stopping controlling the mobile terminal B in the current conference call not to transmit the service data;

stopping controlling the mobile terminal B not to transmit the service data according to the received second request; and

transmitting a second acknowledgement response to the host mobile terminal A.

In the above-described embodiment, it can be realized that, the host terminal side transmits a request to the network for muting a part of subscribers in the conference call i.e. the mobile terminal B and the mobile terminal C, and the part of subscribers can be stopped from being muted after the second request transmitted by the host mobile terminal A is received.

In some embodiments, a mobile terminal A, a mobile terminal B and a mobile terminal C are making a conference call, where the mobile terminal A is a host.

The method for managing a conference call that is applied to the terminal side may include the following steps:

transmitting a first request to a network, so that the network can control service data of the mobile terminal B in the current conference call only to be transmitted to the mobile terminal C, and control service data of the mobile terminal C only to be transmitted to the mobile terminal B;

receiving a first acknowledgement response returned by the network;

transmitting a second request to the network, so that the network can stop controlling service data of the mobile terminal B in the current conference call only to be transmitted to the mobile terminal C, and stop controlling service data of the mobile terminal C only to be transmitted to the mobile terminal B; and

receiving a second acknowledgement response returned by the network.

The method for managing a conference call that is applied to the network may include the following steps:

receiving the first request transmitted by the mobile terminal A, so that the network can control service data of the mobile terminal B in the current conference call only to be transmitted to the mobile terminal C, and control service data of the mobile terminal C only to be transmitted to the mobile terminal B;

forwarding service data to the mobile terminal B and the mobile terminal C according to the received first request;

transmitting a first acknowledgement response to the host mobile terminal A;

receiving the second request transmitted by the host mobile terminal A for stopping controlling the service data of the mobile terminal B in the current conference call only to be transmitted to the mobile terminal C, and stopping controlling the service data of the mobile terminal C only to be transmitted to the mobile terminal B;

stopping directional forwarding service data to the mobile terminal B and to the mobile terminal C according to the received second request; and

transmitting a second acknowledgement response to the host mobile terminal A.

In the above embodiments, it can be realized that, the host mobile terminal A transmits a request to the network, so that a partial conference can be made among a part of subscribers in the conference call, i.e. the mobile terminal B and the mobile terminal C, and the partial conference can also be cancelled.

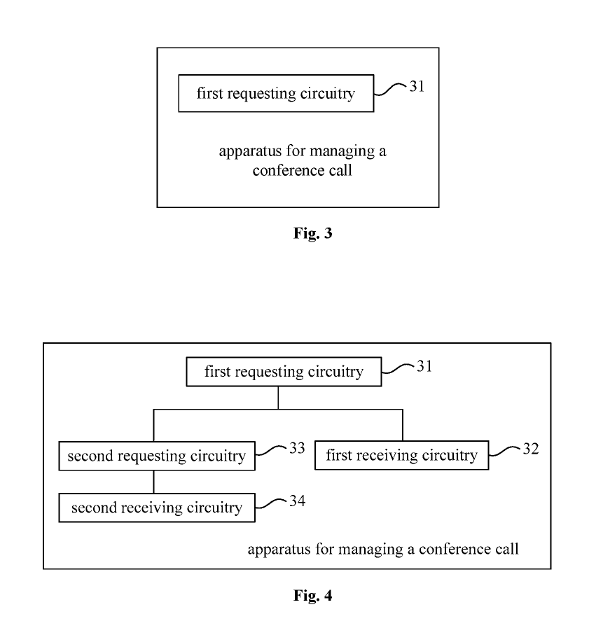

An apparatus for managing a conference call is also provided according to embodiments of the present disclosure. Referring to FIG. 3, the apparatus may include a first requesting circuitry 31.

The first requesting circuitry 31 is configured to transmit a first request to a network during a current conference call, so that the network can control at least one end of the current conference call not to transmit service data, or the network cannot forward the service data of the at least one end to other ends of the conference call, or the network can forward the service data of the at least one end to designated ends of the conference call.

In the apparatus for managing a conference call according to embodiments of the present disclosure, a first request is transmitted to a network during a current conference call, so that the network can control at least one end in the current conference call not to transmit service data, or the network cannot forward the service data of the at least one end to other ends in the conference call, or the network can forward the service data of the at least one end to designated ends of the conference call. Compared with the existing technology, designated subscribers in a conference call can be muted and a partial conference can be made among designated subscribers in the conference call, therefore diversified demands of users can be satisfied.

Referring to FIG. 4, in some embodiments, the apparatus may further include a first receiving circuitry 32, which is configured to receive a first acknowledgment response returned by the network, after the first requesting circuitry transmits the first request to the network during the current conference call, so that the network can control the at least one end of the current conference call not to transmit service data, or the network cannot forward the service data of the at least one end to other ends of the conference call, or the network can forward the service data of the at least one end to designated ends of the conference call.

Referring to FIG. 4, in some embodiments, the apparatus may further include a second requesting circuitry 33 and a second receiving circuitry 34. The second requesting circuitry 33 is configured to transmit a second request to the network, so that the network can stop controlling at least one end of the current conference call not to transmit the service data, or the network can stop not forwarding the service data of the at least one end to other ends of the conference call, or the network can stop forwarding the service data of the at least one end to designated ends of the conference call, after the first requesting circuitry transmits the first request to the network during the current conference call, so that the network can control the at least one end of the current conference call not to transmit service data, or the network cannot forward the service data of the at least one end to other ends of the conference call, or the network can forward the service data of the at least one end to designated ends of the conference call; and the second receiving circuitry 34 is configured to receive a second acknowledgment response returned by the network.

In some embodiments, the apparatus may be located at a terminal based on IP multimedia network.

In some embodiments, the apparatus may be located at a terminal based on IP Multimedia Subsystem (IMS) network.

In some embodiments, the apparatus may be located at a terminal supporting Voice over LTE (VoLTE) or a terminal supporting Voice over WiFi (VoWiFi).

An apparatus for managing a conference call that is located at a network is also provided according to embodiments of the present disclosure. Referring to FIG. 5, the apparatus may include a third receiving circuitry 51 and a first controlling circuitry 52. The third receiving circuitry 51 is configured to receive a first request transmitted by a terminal side during a current conference call, and the first controlling circuitry 52 is configured to control at least one end of the current conference call not to transmit service data, or to control the network not to forward the service data of the at least one end to other ends of the conference call, or to control the network to forward the service data of the at least one end to designated ends of the conference call according to the first request transmitted by the terminal side.

In the apparatus for managing a conference call that is located at a network according to the embodiments of the present disclosure, the first request transmitted by the terminal side during the current conference call is received, and the at least one end of the current conference call is controlled not to transmit service data, or the network is controlled not to forward the service data of the at least one end to other ends of the conference call, or the network is controlled to forward the service data of the at least one end to designated ends of the conference call according to the first request transmitted by the terminal side. Compared with the existing technology, designated subscribers in a conference call can be muted and a partial conference can be made among designated subscribers in the conference call, therefore diversified demands of users can be satisfied.

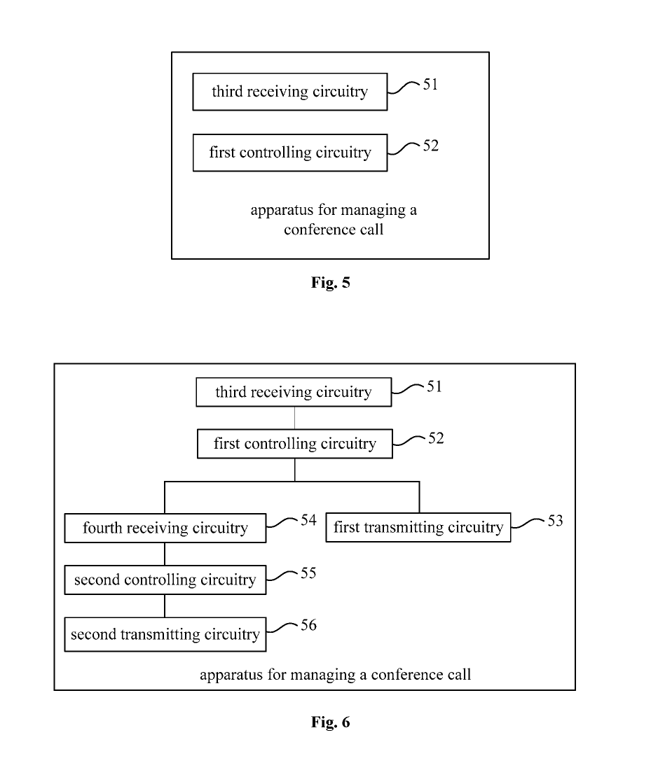

Referring to FIG. 6, in some embodiments, the apparatus may further include a first transmitting circuitry 53, which is configured to transmit a first acknowledgment response to the terminal side, after the first controlling circuitry controls the at least one end of the current conference call not to transmit service data, or controls the network not to forward the service data of the at least one end to other ends of the conference call, or controls the network to forward the service data of the at least one end to designated ends of the conference call according to the first request transmitted by the terminal side.

Referring to FIG. 6, in some embodiments, the apparatus may further include a fourth receiving circuitry 54, a second controlling circuitry 55 and a second transmitting circuitry 56. The fourth receiving circuitry 54 is configured to receive a second request transmitted by the terminal side, after the first controlling circuitry controls the at least one end of the current conference call not to transmit service data, or controls the network not to forward the service data of the at least one end to other ends of the conference call, or controls the network to forward the service data of the at least one end to designated ends of the conference call according to the first request transmitted by the terminal side; the second controlling circuitry 55 is configured to stop controlling at least one end of the current conference call not to transmit the service data, or to stop controlling the network not to forward the service data of the at least one end to other ends of the conference call, or to stop controlling the network to forward the service data of the at least one end to designated ends of the conference call; and the second transmitting circuitry 56 is configured to transmit a second acknowledgement response to the terminal side. The terminal side may be a host terminal.

Compared with the existing technology, designated subscribers in a conference call can be muted and a partial conference can be made among designated subscribers in a conference call according to the first request transmitted by the terminal side, and then designated users in the conference call can be stopped from being muted and the conference call among all ends can be restored according to the second request transmitted by the terminal side.

A terminal is also provided according to embodiments of the present disclosure. The terminal includes the aforementioned apparatus for managing a conference call. The apparatus for managing a conference call may include a first requesting circuitry which is configured to transmit a first request to a network during a current conference call, so that the network can control at least one end of the current conference call not to transmit service data, or the network cannot forward the service data of the at least one end to other ends of the conference call, or the network can forward the service data of the at least one end to designated ends of the conference call.

A network device is also provided according to embodiments of the present disclosure. The network device includes the aforementioned apparatus for managing a conference call that is located at the network. The apparatus for managing a conference call may include a third receiving circuitry, configured to receive a first request transmitted by a terminal side during a current conference call; and a first controlling circuitry, configured to control at least one end of the current conference call not to transmit service data, or to control the network not to forward the service data of the at least one end to other ends of the conference call, or to control the network to forward the service data of the at least one end to designated ends of the conference call according to the first request transmitted by the terminal side.

It will be understood by those of ordinary skill in the art that all or part of the processes in the method of the embodiments described above may be implemented by means of a computer program commanding associated hardware, where the computer program may be stored in a computer-readable storage medium. During execution of the program, procedures of embodiments as described above may be included. The storage medium may be a magnetic disk, an optical disk, a read-only memory (ROM), a random access memory (RAM), or the like.

Although the present disclosure has been described above, the present disclosure is not limited thereto. It should be understood by those skilled in the art that various changes and modifications may be made without departing from the spirit and scope of the disclosure, and therefore, the scope of the disclosure should be limited by the scope of the claims.

What is claimed is:

1. A method for managing a conference call, comprising:
transmitting a first request to a network during the current conference call, wherein the network is configured to control at least one end of the current conference call not to transmit service data, or the network cannot forward the service data of the at least one end to other ends of the conference call, or the network is configured to forward the service data of the at least one end to designated ends of the conference call.

2. The method according to claim 1, wherein after transmitting the first request to the network during the current conference call, so that the network is configured to control at least one end of the current conference call not to transmit service data, or the network cannot forward the service data of the at least one end to other ends of the conference call, or the network is configured to forward the service data of the at least one end to designated ends of the conference call, the method further comprises:
receiving an acknowledgment response returned by the network.

3. The method according to claim 1, wherein after transmitting the first request to the network, so that the network is configured to control the at least one end of the current conference call not to transmit service data, or the network cannot forward the service data of the at least one end to other ends of the conference call, or the network is configured to forward the service data of the at least one end to designated ends of the conference call, the method further comprises:
transmitting a second request to the network, so that the network is configured to stop controlling at least one end of the current conference call not to transmit the service data, or the network is configured to stop not forwarding the service data of the at least one end to other ends of the conference call, or the network is configured to stop forwarding the service data of the at least one end to designated ends of the conference call; and
receiving an acknowledgment response returned by the network.

4. The method according to claim 2, wherein the method is applied to a terminal based on IP multimedia network, or to a terminal based on IP Multimedia Subsystem (IMS) network.

5. The method according to claim 3, wherein the method is applied to a terminal based on IP multimedia network, or to a terminal based on IMS network.

6. The method according to claim 2, wherein the method is applied to a terminal supporting Voice over LTE (VoLTE) or a terminal supporting Voice over WiFi (VoWiFi).

7. A method for managing a conference call, applied to a network, comprising:
receiving a first request transmitted by a terminal side during a current conference call; and
controlling at least one end of the current conference call not to transmit service data, or controlling the network not to forward the service data of the at least one end to other ends of the conference call, or controlling the network to forward the service data of the at least one end to designated ends of the conference call according to the first request transmitted by the terminal side.

8. The method according to claim 7, further comprising:
transmitting an acknowledgment response to the terminal side, after controlling the at least one end of the current conference call not to transmit service data, or controlling the network not to forward the service data of the at least one end to other ends of the conference call, or controlling the network to forward the service data of the at least one end to designated ends of the conference call according to the first request transmitted by the terminal side.

9. The method according to claim 7, wherein after controlling the at least one end of the current conference call not to transmit service data, or controlling the network not to forward the service data of the at least one end to the other ends of the conference call, or controlling the network to forward the service data of the at least one end to designated ends of the conference call according to the first request transmitted by the terminal side, the method further comprises:
receiving a second request transmitted by the terminal side;
stopping controlling at least one end of the current conference call not to transmit the service data, or stopping controlling the network not to forward the service data of the at least one end to other ends of the conference call, or stopping controlling the network to forward the service data of the at least one end to designated ends of the conference call; and
transmitting an acknowledgement response to the terminal side.

10. An apparatus for managing a conference call, comprising:
a first requesting circuitry, configured to transmit a first request to a network during the current conference call, so that the network is configured to control at least one end of the current conference call not to transmit service data, or the network cannot forward the service data of the at least one end to other ends of the conference call, or the network is configured to forward the service data of the at least one end to designated ends of the conference call.

11. The apparatus according to claim 10, further comprising:
a first receiving circuitry, configured to receive an acknowledgment response returned by the network, after the first requesting circuitry transmits the first request to the network during the current conference call, so that the network is configured to control the at least one end of the current conference call not to transmit service data, or the network cannot forward the service data of the at least one end to other ends of the conference call, or the network is configured to forward the service data of the at least one end to designated ends of the conference call.

12. The apparatus according to claim 10, further comprising:
a second requesting circuitry, configured to transmit a second request to the network, so that the network is configured to stop controlling at least one end of the current conference call not to transmit the service data, or the network is configured to stop not forwarding the service data of the at least one end to other ends of the conference call, or the network is configured to forward the service data of the at least one end to designated ends of the conference call, after the first requesting circuitry transmits the first request to the network during the current conference call, so that the network is configured to control the at least one end of the current conference call not to transmit service data, or the network cannot forward the service data of the at least one end to other ends of the conference call, or the network is configured to forward the service data of the at least one end to designated ends of the conference call; and
a second receiving circuitry, configured to receive an acknowledgment response returned by the network.

13. The apparatus according to claim 11, wherein the apparatus is located at a terminal based on IP multimedia network or located at a terminal based on IP Multimedia Subsystem (IMS) network.

14. The apparatus according to claim 12, wherein the apparatus is located at a terminal based on IP multimedia network or at a terminal based on IMS network.

15. The apparatus according to claim 11, wherein the apparatus is located at a terminal supporting Voice over LTE (VoLTE) or a terminal supporting Voice over WiFi (VoWiFi).

16. The apparatus according to claim 12, wherein the apparatus is located at a terminal supporting Voice over LTE (VoLTE) or a terminal supporting Voice over WiFi (VoWiFi).

17. An apparatus for managing a conference call, located at a network, comprising:
a third receiving circuitry, configured to receive a first request transmitted by a terminal side during a current conference call; and
a first controlling circuitry, configured to control at least one end of the current conference call not to transmit service data, or to control the network not to forward the service data of the at least one end to other ends of the conference call, or to control the network to forward the service data of the at least one end to designated ends of the conference call according to the first request transmitted by the terminal side.

18. The apparatus according to claim 17, further comprising:
a first transmitting circuitry, configured to transmit an acknowledgment response to the terminal side, after the first controlling circuitry controls the at least one end of the current conference call not to transmit service data, or controls the network not to forward the service data of the at least one end to other ends of the conference call, or controls the network to forward the service data of the at least one end to designated ends of the conference call according to the first request transmitted by the terminal side.

19. The apparatus according to claim 17, further comprising:
a fourth receiving circuitry, configured to receive a second request transmitted by the terminal side, after the first controlling circuitry controls the at least one end of the current conference call not to transmit service data, or controls the network not to forward the service data of the at least one end to other ends of the conference call, or controls the network to forward the service data of the at least one end to designated ends of the conference call according to the first request transmitted by the terminal side;
a second controlling circuitry, configured to stop controlling at least one end of the current conference call not to transmit the service data, or to stop controlling the network not to forward the service data of the at least one end to other ends of the conference call, or to stop controlling the network to forward the service data of the at least one end to designated ends of the conference call; and
a second transmitting circuitry, configured to transmit an acknowledgement response to the terminal side.

20. A terminal, comprising: an apparatus for managing a conference call;
wherein the apparatus for managing a conference call comprises:
a first requesting circuitry, configured to transmit a first request to a network during the current conference call, so that the network is configured to control at least one end of the current conference call not to transmit service data, or the network cannot forward the service data of the at least one end to other ends of the conference call, or the network is configured to forward the service data of the at least one end to designated ends of the conference call.

21. A network device, comprising: an apparatus for managing a conference call;
wherein the apparatus for managing a conference call comprises:
a third receiving circuitry, configured to receive a first request transmitted by a terminal side during a current conference call; and
a first controlling circuitry, configured to control at least one end of the current conference call not to transmit service data, or to control the network not to forward the service data of the at least one end to other ends of the conference call, or to control the network to forward the service data of the at least one end to designated ends of the conference call according to the first request transmitted by the terminal side.
